(19) United States
(12) Patent Application Publication
(10) Pub. No.: US 2010/0232311 A1
(43) Pub. Date: Sep. 16, 2010

(54) CONCURRENT TRANSMISSION OF ACK/NACK, CQI AND CQI FROM USER EQUIPMENT

(75) Inventors: Xiaoxia Zhang, San Diego, CA (US); Zhifei Fan, San Diego, CA (US); Juan Montojo, San Diego, CA (US); Hao Xu, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/723,469

(22) Filed: Mar. 12, 2010

Related U.S. Application Data
(60) Provisional application No. 61/159,782, filed on Mar. 12, 2009.

(51) Int. Cl. H04L 12/26

(52) U.S. Cl. 370/252

(57) ABSTRACT

A wireless communications method is provided. The method includes providing a multi-codeword transmission that includes ACK/NACK and discontinuous transmission (DTX) information. The method also includes ordering reference signal (RS) symbols in proximity to at least one other reference signal symbol to facilitate signaling of additional states and enabling spreading gain to be increased.

### CROSS-REFERENCE TO RELATED APPLICATIONS

This application claims the benefit of U.S. Provisional Patent Application No. 61/159,782, titled “Concurrent Transmission of ACK and CQI from User Equipment,” filed Mar. 12, 2009, the contents of which are hereby incorporated by reference in its entirety.

### BACKGROUND

I. Field

The following description relates generally to wireless communications systems, and more particularly increasing information embedding in reference signals.

II. Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including E-UTRA, and orthogonal frequency division multiple access (OFDMA) systems.

An orthogonal frequency division multiplex (OFDM) communication system effectively partitions the overall system bandwidth into multiple (N_{F}) subcarriers, which may also be referred to as frequency sub-channels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier. Thus, OFDM may be used to combat inter-symbol interference (ISI) caused by frequency selective fading, which is characterized by different amounts of attenuation across the system bandwidth.

Generally, a wireless multiple-access communication system can concurrently support communication for multiple wireless terminals that communicate with one or more base stations via transmissions on forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple transmit antennas N_{T} and multiple receive antennas N_{R} for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Generally, each of the N_{S} independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows estimation of the forward link channel from the reverse link channel. This enables an access point to extract transmit beam-forming gain on the forward link when multiple antennas are available at the access point.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

Systems and methods are provided to facilitate wireless communications. In one aspect, a method for communicating handshaking information using reference signals (RSs) in a wireless communications system, comprising: placing RS symbols in a packetized transmission to facilitate signaling of at least one of ACK/NACK, channel quality indicator (CQI), and discontinuous transmission (DTX) information.

In another aspect, an apparatus for communicating handshaking information using reference signals (RSs) in a wireless communications system is provided, comprising: means for placing RS symbols in a packetized transmission to facilitate signaling of at least one of ACK/NACK, channel quality indicator (CQI), and discontinuous transmission (DTX) information.

In another aspect, a wireless communication device for communicating handshaking information using reference signals (RSs) in a wireless communications system is provided, comprising: an RS component that places RS symbols in a packetized transmission to facilitate signaling of at least one of ACK/NACK, channel quality indicator (CQI), and discontinuous transmission (DTX) information.

In another aspect, a computer program product is provided comprising: a computer-readable medium comprising: code for communicating handshaking information using reference signals (RSs) in a wireless communications system by placing RS symbols in a packetized transmission to facilitate signaling of at least one of ACK/NACK, channel quality indicator (CQI), and discontinuous transmission (DTX) information.

In another aspect, an apparatus communicating handshaking information using reference signals (RSs) in a wireless communications system is provided, comprising: a processor, configured to control operations for: placing RS symbols in a packetized transmission to facilitate signaling of at least one of ACK/NACK, channel quality indicator (CQI), and discontinuous transmission (DTX) information; and a memory coupled to the processor for storing data.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high level block diagram of a system that employs reference symbol components for wireless nodes.

FIG. 2 illustrates an example communications apparatus.

FIG. 3 illustrates a multiple access wireless communication system.

FIGS. 4 and 5 illustrate example communications systems.

FIG. 6 depicts an RS UL frame/subframe arrangement for CQI alone with normal CP.

FIGS. 7 and 8 illustrate simulation results for varying scenarios.

FIG. 9 depicts an exemplary RS structure.

FIG. 10 depicts another exemplary RS structure.

FIG. 11 depicts a flow chart illustrating an exemplary process.

FIG. 12 depicts a software implementation configuration.

### DETAILED DESCRIPTION

For the purposes of the present document, the following abbreviations apply, unless otherwise noted:
AM Acknowledged Mode
AMD Acknowledged Mode Data
ARQ Automatic Repeat Request
BCCH Broadcast Control CHannel
BCH Broadcast CHannel
C- Control-
CCCH Common Control CHannel
CCH Control CHannel
CCTrCH Coded Composite Transport Channel
CP Cyclic Prefix
CRC Cyclic Redundancy Check
CTCH Common Traffic CHannel
DCCH Dedicated Control CHannel
DCH Dedicated CHannel
DL DownLink
DSCH Downlink Shared CHannel
DTCH Dedicated Traffic CHannel
ECI Extended Channel Information
FACH Forward link Access CHannel
FDD Frequency Division Duplex
L1 Layer 1 (physical layer)
L2 Layer 2 (data link layer)
L3 Layer 3 (network layer)
LI Length Indicator
LSB Least Significant Bit
MAC Medium Access Control
MBMS Multimedia Broadcast Multicast Service
MCCH MBMS point-to-multipoint Control CHannel
MRW Move Receiving Window
MSB Most Significant Bit
MSCH MBMS point-to-multipoint Scheduling CHannel
MTCH MBMS point-to-multipoint Traffic CHannel
PBCCH Primary Broadcast Control CHannel
PBCH Physical Broadcast CHannel
PCCH Paging Control CHannel
PCH Paging CHannel
PDU Protocol Data Unit
PHY PHYsical layer
PhyCH Physical CHannels
QPCH Quick Paging CHannel
RACH Random Access CHannel
RLC Radio Link Control
RRC Radio Resource Control
SAP Service Access Point
SBCCH Secondary Broadcast Control CH
SDU Service Data Unit
SHCCH SHared channel Control CHannel
SN Sequence Number
SSCH Shared Signaling CHannel
SUFI SUper FIeld
TCH Traffic CHannel
TDD Time Division Duplex
TFI Transport Format Indicator
TM Transparent Mode
TMD Transparent Mode Data
TTI Transmission Time Interval
U- User-
UE User Equipment
UL UpLink
UM Unacknowledged Mode
UMD Unacknowledged Mode Data
UMTS Universal Mobile Telecommunications System
UTRA UMTS Terrestrial Radio Access
UTRAN UMTS Terrestrial Radio Access Network
MBSFN Multicast Broadcast Single Frequency Network
MCE MBMS Coordinating Entity
MCH Multicast CHannel
DL-SCH Downlink Shared CHannel
MSCH MBMS Control CHannel
PDCCH Physical Downlink Control CHannel
PDSCH Physical Downlink Shared CHannel

Signal channels can be described in terms of physical channels and/or logical channels, where logical channels are classified into Control Channels and Traffic Channels. Logical Control Channels comprises Broadcast Control Channel (BCCH), which is a DL channel for broadcasting system control information; Paging Control Channel (PCCH), which is a DL channel that transfers paging information; Multicast Control Channel (MCCH), which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is a Point-to-point bi-directional channel that transmits dedicated control information and used by UEs having an RRC connection. In one aspect, Logical Traffic Channels can comprise a Dedicated Traffic Channel (DTCH), which is a point-to-point bi-directional channel, dedicated to one UE, for the transfer of user information. Also, a there is a Multicast Traffic Channel (MTCH) for Point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprises a set of DL channels and UL channels.

Other terms include: 3G 3rd Generation, 3GPP 3rd Generation Partnership Project, ACLR Adjacent channel leakage ratio, ACPR Adjacent channel power ratio, ACS Adjacent channel selectivity, ADS Advanced Design System, AMC Adaptive modulation and coding, A-MPR Additional maximum power reduction, ARQ Automatic repeat request, BCCH Broadcast control channel, BTS Base transceiver station, CDD Cyclic delay diversity, CCDF Complementary cumulative distribution function, CDMA Code division multiple access, CFI Control format indicator, Co-MIMO Cooperative MIMO, CP Cyclic prefix, CPICH Common pilot channel, CPRI Common public radio interface, CQI Channel quality indicator, CRC Cyclic redundancy check, DCI Downlink control indicator, DFT Discrete Fourier transform, DFT-SOFDM Discrete Fourier transform spread OFDM, DL Downlink (base station to subscriber transmission), DL-SCH Downlink shared channel, D-PHY 500 Mbps physical layer, DSP Digital signal processing, DT Development toolset, DVSA Digital vector signal analysis, EDA Electronic design automation, E-DCH Enhanced dedicated channel, E-UTRAN Evolved UMTS terrestrial radio access network, eMBMS Evolved multimedia broadcast multicast service, eNB Evolved Node B, EPC Evolved packet core, EPRE Energy per resource element, ETSI European Telecommunications Standards Institute, E-UTRA Evolved UTRA, E-UTRAN Evolved UTRAN, EVM Error vector magnitude, and FDD Frequency division duplex.

Still yet other terms include FFT Fast Fourier transform, FRC Fixed reference channel, FS1 Frame structure type 1, FS2 Frame structure type 2, GSM Global system for mobile communication, HARQ Hybrid automatic repeat request, HDL Hardware description language, HI HARQ indicator, HSDPA High speed downlink packet access, HSPA High speed packet access, HSUPA High speed uplink packet access, IFFT Inverse FFT, IOT Interoperability test, IP Internet protocol, LO Local oscillator, LTE Long term evolution, MAC Medium access control, MBMS Multimedia broadcast multicast service, MBSFN Multicast/broadcast over single-frequency network, MCH Multicast channel, MIMO Multiple input multiple output, MISO Multiple input single output, MME Mobility management entity, MOP Maximum output power, MPR Maximum power reduction, MU-MIMO Multiple user MIMO, NAS Non-access stratum, OBSAI Open base station architecture interface, OFDM Orthogonal frequency division multiplexing, OFDMA Orthogonal frequency division multiple access, PAPR Peak-to-average power ratio, PAR Peak-to-average ratio, PBCH Physical broadcast channel, P-CCPCH Primary common control physical channel, PCFICH Physical control format indicator channel, PCH Paging channel, PDCCH Physical downlink control channel, PDCP Packet data convergence protocol, PDSCH Physical downlink shared channel, PHICH Physical hybrid ARQ indicator channel, PHY Physical layer, PRACH Physical random access channel, PMCH Physical multicast channel, PMI Pre-coding matrix indicator, P-SCH Primary synchronization signal, PUCCH Physical uplink control channel, and PUSCH Physical uplink shared channel.

Other terms include QAM Quadrature amplitude modulation, QPSK Quadrature phase shift keying, RACH Random access channel, RAT Radio access technology, RB Resource block, RF Radio frequency, RFDE RF design environment, RLC Radio link control, RMC Reference measurement channel, RNC Radio network controller, RRC Radio resource control, RRM Radio resource management, RS Reference signal, RSCP Received signal code power, RSRP Reference signal received power, RSRQ Reference signal received quality, RSSI Received signal strength indicator, SAE System architecture evolution, SAP Service access point, SC-FDMA Single carrier frequency division multiple access, SFBC Space-frequency block coding, S-GW Serving gateway, SIMO Single input multiple output, SISO Single input single output, SNR Signal-to-noise ratio, SRS Sounding reference signal, S-SCH Secondary synchronization signal, SU-MIMO Single user MIMO, TDD Time division duplex, TDMA Time division multiple access, TR Technical report, TrCH Transport channel, TS Technical specification, TTA Telecommunications Technology Association, TTI Transmission time interval, UCI Uplink control indicator, UE User equipment, UL Uplink (subscriber to base station transmission), UL-SCH Uplink shared channel, UMB Ultra-mobile broadband, UMTS Universal mobile telecommunications system, UTRA Universal terrestrial radio access, UTRAN Universal terrestrial radio access network, VSA Vector signal analyzer, W-CDMA Wideband code division multiple access.

Universal Mobile Telecommunications System (UMTS) is one of the third-generation (3G) wireless phone technologies. Currently, the most common form of UMTS uses W-CDMA as the underlying air interface. UMTS is standardized by the 3rd Generation Partnership Project (3GPP), and is sometimes marketed as 3GSM as a way of emphasizing the combination of the 3G nature of the technology and the GSM standard which it was designed to succeed.

UTRA (UMTS Terrestrial Radio Access) is the physical layer term for Node-B′s and UTRAN (UMTS Terrestrial Radio Access Network) is a collective term for the Node-B′s and Radio Network Controllers which make up the UMTS radio access network. The UTRAN allows connectivity between the UE and a core network, and can include Ues, Node Bs, and Radio Network Controllers (RNCs)—noting that an RNC and Nod-B can be the same device, although typical implementations have a separate RNC located in a central office serving multiple Node B′s. EUTRA (Enhanced UMTS Terrestrial Radio Access—LTE) is the physical layer term for eNode-B′s and EUTRAN is the enhanced UTRAN.

For LTE, a Broadcast Channel (BCH) may have a fixed pre-defined transport format and may be broadcasted over the entire coverage area of a cell. In LTE, the broadcast channel may be used to transmit a “System Information field” necessary for system access. However, due to the large size of a System Information field, the BCH may divided into two portions including a Primary Broadcast CHannel (P-BCH) and Dynamic Broadcast CHannel (D-BCH). The P-BCH may contain basic Layer 1 (physical layer)/Layer 2 (data link layer) (or “L1/L2”) system parameters useful to demodulate the D-BCH, which in turn may contain the remaining System Information field.

For a MIMO-OFDM system, the N_{F} frequency subchannels of each spatial subchannel may experience different channel conditions (e.g., different fading and multipath effects) and may achieve different signal-to-noise-and-interference ratios (SNRs). Each transmitted modulation symbol is affected by the response of the transmission channel via which the symbol was transmitted. Depending on the multipath profile of the communication channel between the transmitter and receiver, the frequency response may vary widely throughout the system bandwidth for each spatial subchannel, and may further vary widely among the spatial subchannels. Reference tones or reference signals (RS) embedded in the channels can be used to gauge the “quality” of the channels/subchannels. These RS's are spaced in a unique manner in the transmitted packet. However, the spacing and nature of the RS's can be exploited to provide additional information, as further described herein.

The techniques described herein may be used, depending on implementation specifics, for various wireless communication networks such as CDMA networks, TDMA networks, FDMA networks, OFDMA networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

### INTRODUCTION

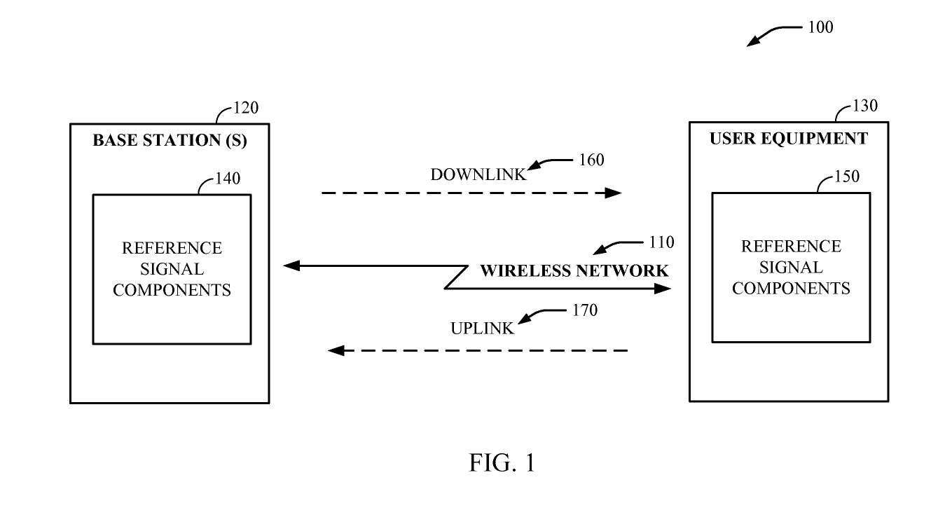

FIG. 1 is an illustration of a system 100 which employs reference signal components in a wireless network 110. The system 100 includes one or more base stations 120 (also referred to as a node, evolved node B-eNB, serving eNB, target eNB, femto station, pico station, and so forth) which can be an entity capable of communication over the wireless network 110 to various devices 130. For instance, each device 130 can be an access terminal (also referred to as terminal, user equipment, mobility management entity (MME) or mobile device). The components 120 and 130 can include reference signal components 140 and 150 respectively. As shown, the base station 120 communicates to the station 130 via downlink 160 and receives data via uplink 170. Such designation as uplink and downlink is arbitrary as the device 130 can also transmit data via downlink and receive data via uplink channels. It is noted that although two components 120 and 130 are shown, more than two components can be employed on the network 110, where such additional components can also be adapted for signal processing described herein.

It is noted that the system 100 can be employed with an access terminal or mobile device, and can be, for instance, a module such as an SD card, a network card, a wireless network card, a computer (including laptops, desktops, personal digital assistants PDAs), mobile phones, smart phones, or any other suitable terminal that can be utilized to access a network. The terminal accesses the network by way of an access component (not shown). In one example, a connection between the terminal and the access components may be wireless in nature, in which access components may be the base station and the mobile device is a wireless terminal. For instance, the terminal and base stations may communicate by way of any suitable wireless protocol, including but not limited to TDMA, CDMA, FDMA, OFDM, FLASH OFDM, OFDMA, or any other suitable protocol.

Access components can be an access node associated with a wired network or a wireless network. To that end, access components can be, for instance, a router, a switch, or the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

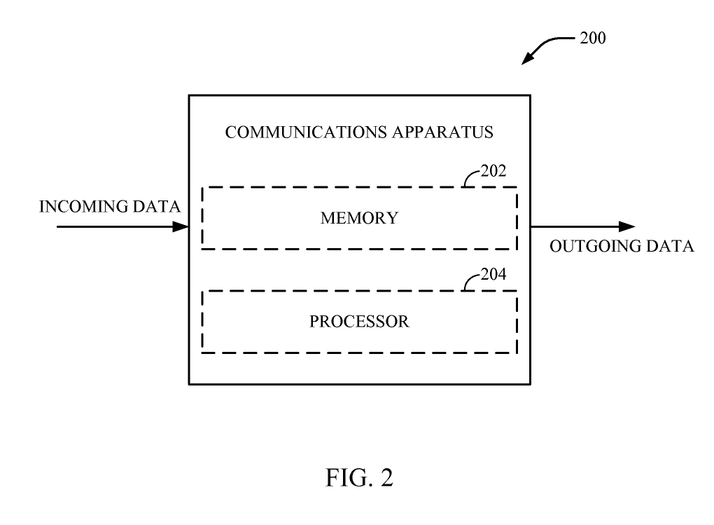

FIG. 2 illustrates a communications apparatus 200 that can be a wireless communications apparatus, for instance, such as a wireless terminal. Additionally or alternatively, communications apparatus 200 can be resident within a wired network. Communications apparatus 200 can include memory 202 that can retain instructions for performing a signal analysis in a wireless communications terminal. Additionally, communications apparatus 200 may include a processor 204 that can execute instructions within memory 202 and/or instructions received from another network device, wherein the instructions can relate to configuring or operating the communications apparatus 200 or a related communications apparatus.

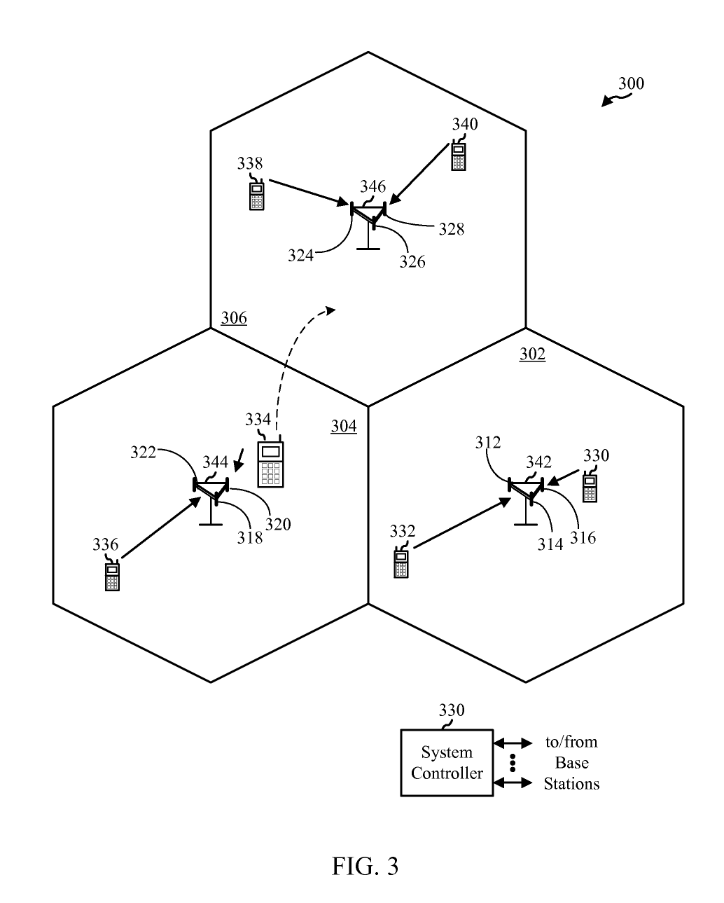

Referring to FIG. 3, a multiple access wireless communication system 300 is illustrated. The multiple access wireless communication system 300 includes multiple cells, including cells 302, 304, and 306. In this aspect of the system 300, the cells 302, 304, and 306 may include a Node B that includes multiple sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 can include several wireless communication devices, e.g., User Equipment or UEs, which can be in communication with one or more sectors of each cell 302, 304 or 306. For example, UEs 330 and 332 can be in communication with Node B 342, UEs 334 and 336 can be in communication with Node B 344, and UEs 338 and 340 can be in communication with Node B 346.

Referring now to FIG. 4, a multiple access wireless communication system according to one aspect is illustrated. An access point 400 (AP) includes multiple antenna groups, one including 404 and 406, another including 408 and 410, and an additional including 412 and 414. In FIG. 4, only two antennas are shown for each antenna group, however, more or fewer antennas may be utilized for each antenna group. Access terminal 416 (AT) is in communication with antennas 412 and 414, where antennas 412 and 414 transmit information to access terminal 416 over forward link 420 and receive information from access terminal 416 over reverse link 418. Access terminal 422 is in communication with antennas 406 and 408, where antennas 406 and 408 transmit information to access terminal 422 over forward link 426 and receive information from access terminal 422 over reverse link 424. In a FDD system, communication links 418, 420, 424 and 426 may use different frequency for communication. For example, forward link 420 may use a different frequency then that used by reverse link 418.

Each group of antennas and/or the area in which they are designed to communicate is often referred to as a sector of the access point. Antenna groups each are designed to communicate to access terminals in a sector, of the areas covered by access point 400. In communication over forward links 420 and 426, the transmitting antennas of access point 400 utilize beam-forming in order to improve the signal-to-noise ratio of forward links for the different access terminals 416 and 424. Also, an access point using beam-forming to transmit to access terminals scattered randomly through its coverage causes less interference to access terminals in neighboring cells than an access point transmitting through a single antenna to all its access terminals. An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

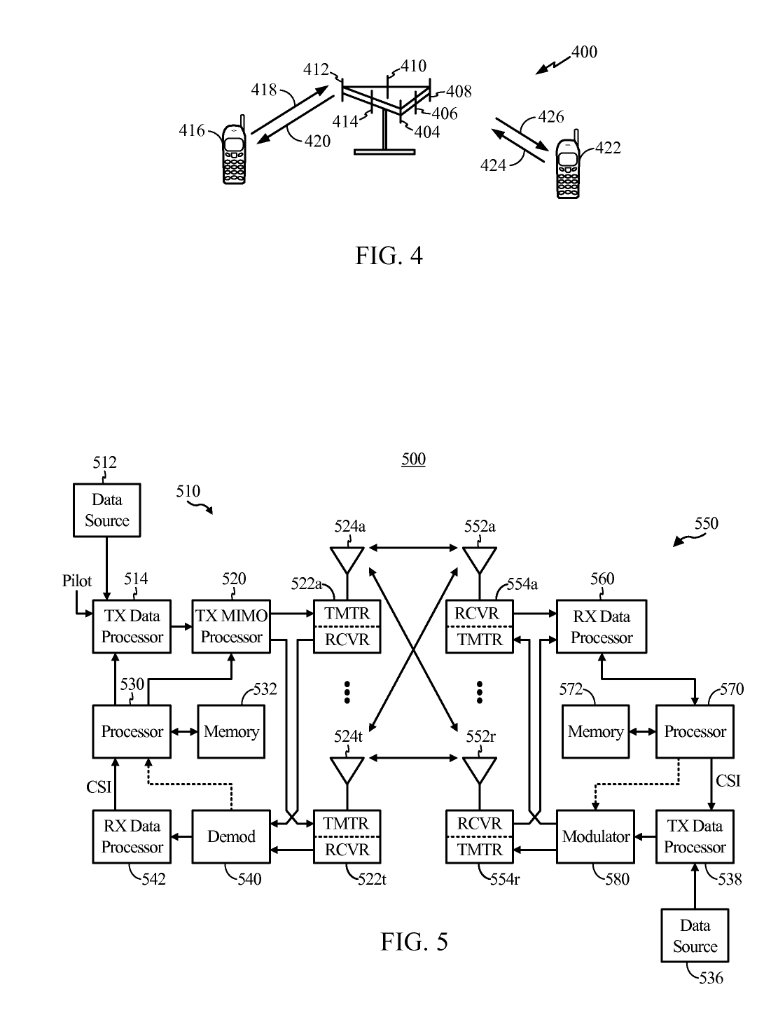

Referring to FIG. 5, a system 500 illustrates a transmitter system 510 (also known as the access point) and a receiver system 550 (also known as access terminal) in a MIMO system 500. At the transmitter system 510, traffic data for a number of data streams is provided from a data source 512 to a transmit (TX) data processor 514. Each data stream is transmitted over a respective transmit antenna. TX data processor 514 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 530, coupled to optional memory 532.

The modulation symbols for all data streams are then provided to a TX MIMO processor 520, which may further process the modulation symbols (e.g., for OFDM). TX MIMO processor 520 then provides N_{T} modulation symbol streams to N_{T} transmitters (TMTR) 522a through 522t. In certain embodiments, TX MIMO processor 520 applies beam-forming weights to the symbols of the data streams and to the antenna from which the symbol is being transmitted.

Each transmitter 522 receives and processes a respective symbol stream to provide one or more analog signals, and further conditions (e.g., amplifies, filters, and up-converts) the analog signals to provide a modulated signal suitable for transmission over the MIMO channel. N_{T} modulated signals from transmitters 522a through 522t are then transmitted from N_{T} antennas 524a through 524t, respectively.

At receiver system 550, the transmitted modulated signals are received by N_{R} antennas 552a through 552r and the received signal from each antenna 552 is provided to a respective receiver (RCVR) 554a through 554r. Each receiver 554 conditions (e.g., filters, amplifies, and down-converts) a respective received signal, digitizes the conditioned signal to provide samples, and further processes the samples to provide a corresponding “received” symbol stream.

An RX data processor 560 then receives and processes the N_{R} received symbol streams from N_{R} receivers 554 based on a particular receiver processing technique to provide N_{T} “detected” symbol streams. The RX data processor 560 then demodulates, de-interleaves, and decodes each detected symbol stream to recover the traffic data for the data stream. The processing by RX data processor 560 is complementary to that performed by TX MIMO processor 520 and TX data processor 514 at transmitter system 510.

A processor 570 periodically determines which pre-coding matrix to use (discussed below). Processor 570 formulates a reverse link message comprising a matrix index portion and a rank value portion. The processor 570 may also utilize optional memory 572. The reverse link message may comprise various types of information regarding the communication link and/or the received data stream. The reverse link message is then processed by a TX data processor 538, which also receives traffic data for a number of data streams from a data source 536, modulated by a modulator 580, conditioned by transmitters 554a through 554r, and transmitted back to transmitter system 510.

At transmitter system 510, the modulated signals from receiver system 550 are received by antennas 524, conditioned by receivers 522, demodulated by a demodulator 540, and processed by a RX data processor 542 to extract the reserve link message transmitted by the receiver system 550. Processor 530 then determines which pre-coding matrix to use for determining the beam-forming weights then processes the extracted message.

ACK, NACK, CQI, DTX

Reference signals (RS) are frequency and time signals that are transmitted to the UE to assist in channel lock and other necessary operations. For example, by using these RS tones, the characteristics of the channel being transmitted can be estimated by the UE. Based on information from the estimated or determined channel characteristics, the symbols detected in the data can be better evaluated for accuracy. The RS tones and data tones are multiplexed in the frequency domain, and the RS tones are sent at a fraction of the transmission time, i.e., only a fraction of symbols sent actually contain RS tones.

ACK/NACK are handshaking acknowledged/not acknowledged signals sent between transmitters and receivers to support connection initiation. CQI is a channel quality indicator that can also be a part of handshaking between transmitters and receivers. It should be appreciated that there may be times where an eNB scheduler is configured such that ACK/NACK and CQI may occur simultaneously. ACK/NACK and CQI can have separate quality of service (QoS). Thus, ACK/NACK does not necessarily take up CQI resources. In those sub-frames where the UE needs to transmit ACK and CQI simultaneously, the current standard is to use modulated RS tones to convey ACK/NACK information for the normal cyclic prefix in the AckCH/CQICH UL channel. Based on the number of bits sent and the modulation type, a fixed set of RS tones will incur some information limitations from the reduced degrees of freedom available, as further made evident below.

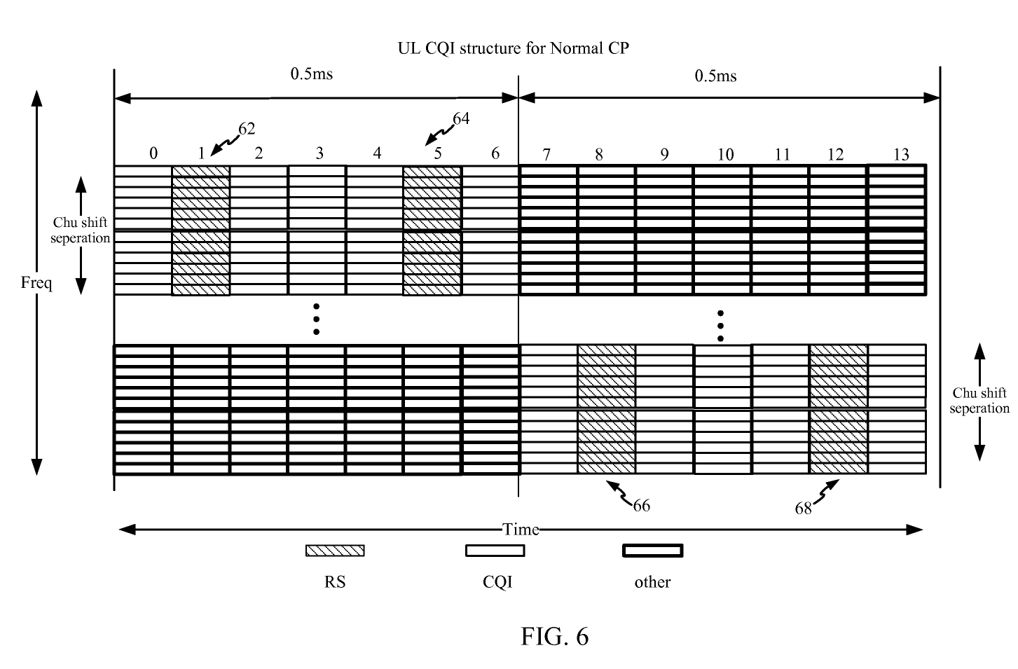

FIG. 6 depicts an RS UL frame/subframe arrangement for CQI alone with normal CP. In the one millisecond frame, the transmission includes a series of OFDM tones spread over symbol slots 0-13. RS symbols 62, 64 are situated 3 symbol slots away from each other in the first subframe (0.0 ms-0.5 ms) and RS symbols 66, 68 are also situated 3 symbol slots from each other in the second subframe (0.5 m-1.0 ms). The RS tones 62, 64, 66, 68 are nonconsecutive in time and separated by three interim symbols carrying CQI information. As each pair of RS symbols is separated an appreciable amount in time from each other, channel variations can affect the performance of ACK/NACK. At the same time, modulating RS symbols with BPSK limits data capacity to two-state information, i.e., ACK or NACK.

However, if only CQI is being sent, then no RS tones are needed for ACK/NACK signaling. If no ACK/NACK is being signaled, then this is equivalent to a DTX indication. (Noting that DTX is discontinuous transmission condition, most likely occurring when the UE or the receiver is not responding or transmitting.)

As an example of sending information using the RS tones, first RS1 tones 62 and 66 of the two subframes can operate as base line signals where the second RS2 tones 64 and 68 of the two subframes are modulated in respect to the baseline signals to provide a “difference” indication. By recognizing the difference between the two signals (e.g., value of RS2 vs. RS1), information can be extracted to indicate ACK/NACK. Per RAN1 decision, only 1 bit of information can be transmitted, by using BPSK—thus, the ACK or NACK limitation.

In those scenarios where there is DL multi-codeword transmission or the UE misses the DL grant (e.g., PDCCH), 2-bit ACK/NACK and DTX information has to be signaled. The additional signaling could be done by increasing the modulation order/constellation, such as by QPSK. However, it has been demonstrated by simulations that the increased modulation order/constellation results in higher error rates for ACK/NACK in a high speed channel.

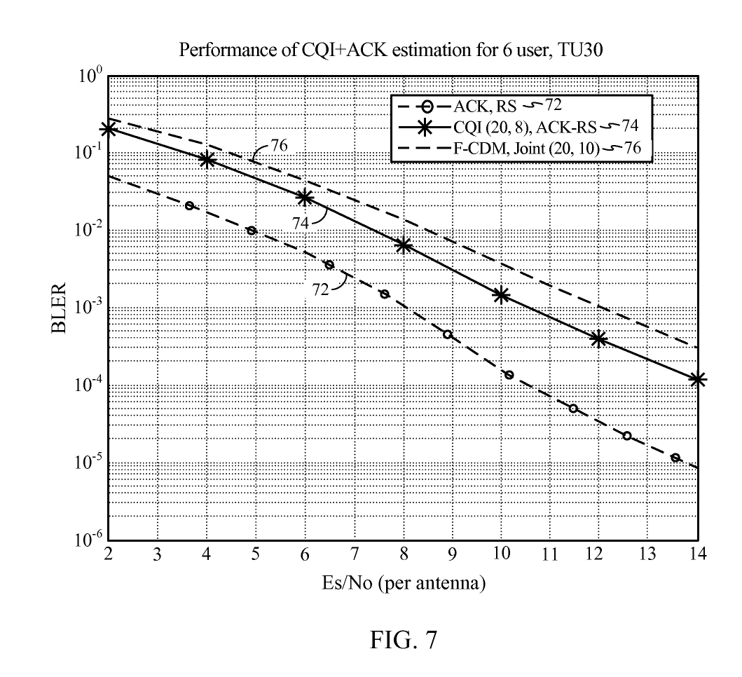

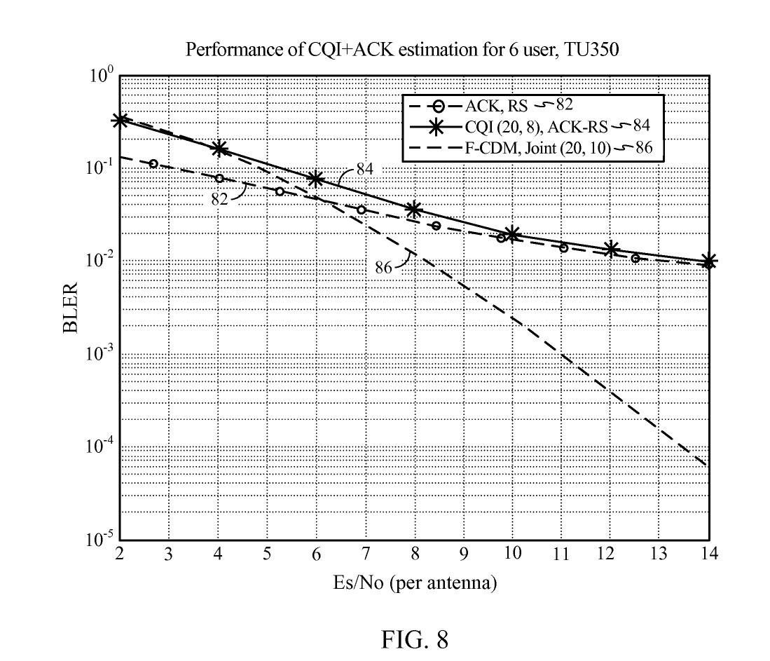

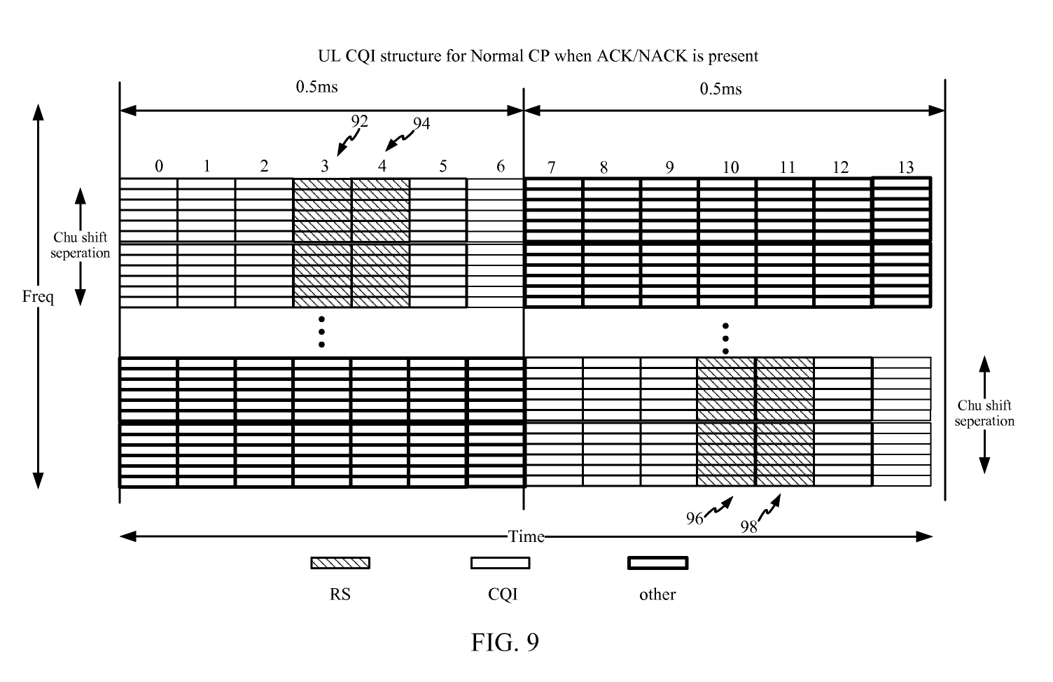

Simulations of such increased error rates are shown in FIGS. 7 and 8, which assume a one bit ACK/NACK 72, 82 (applicable for SIMO and SDMA UEs), and no DTX is addressed. As can be seen in FIGS. 7 and 8, significant performance degradation is observed in high speed channel (FIG. 8) noting that performance gain can be observed in low speed channel (FIG. 7) compared to joint coding 76, 86. Here, joint coding is indicated by the dashed line. CQI is indicated by the “starred” line 74, 84. The performance degradation is understood to be due to the channel variation between the 2 RS symbols described in FIG. 6.

One exemplary approach to addressing the above shortcomings is to place the RS symbols next to each other and possibly adding more RS symbols. The likelihood of successful transmission will increase, more states can be signaled and the spreading gain can be increased. Thus, in the case that a PDCCH is missed by a given UE, DTX can be implicitly signaled using blind detection at the respective eNB based on the RS structure of the UL transmission from the UE.

Specifically, for those sub-frames where the eNB may receive an ACK/NACK, if the RSs take on the regular structure of FIG. 6, DTX can be assumed to be sent. In contrast, if the RSs assume a new/modified transmission structure, ACK/NACK can be assumed to be sent. Thus, by simply recognizing the arrangement of the RSs, another mechanism for transmitting information can be obtained.

It should be noted that in addition to the schemes described above, the performance of blind decoding of DTX can be enhanced by using different shifts/base sequence for RS symbols from those used for data symbols. Therefore, the use of different shifts/base sequence(s) can provide an additional degree of freedom for information transmission

FIG. 9 depicts an exemplary new/modified channel structure where the two related RS symbols 92, 94 and 96, 98 are placed next to one another, i.e., in consecutive slots. This allows for a different RS structure for CQI transmission and for joint CQI+ACK transmission. The ACK/NACK information is signaled in the structure of RS signal and/or additional Walsh or DFT cover. This may have some impact on the CQI performance, but the loss is not expected to be significant. In addition to the above schemes, another exemplary approach can be utilized as described below.

As the relevant transmission standard presently requires BPSK modulation, only one bit of information can be transmitted for each BPSK-modulated RS symbol. For situations where a UE misses a DL grant or the UE is SU-MIMO capable and needs to transmit 2-bit ACK/NACK for two code words, a problem can arise, i.e., how to signal 2-bit ACK/NACK?

It can be noted that 2-bit ACK/NACK information can be conveyed by transmitting one bit on the first slot using BPSK modulated RS and the other bit on the second slot. However, 3 dB of processing gain is lost as well as the diversity gain.

An exemplary alternative is to increase the constellation order to use QPSK and transmit two bits of ACK/NACK information per slot. While diversity is maintained compared to the first alternative, the minimum distance of QPSK is one half of that of BPSK and thus the likelihood of successful data reception at the eNB is decreased. The choice of using this approach versus others described herein can be determined based on the deployment/configuration/operating conditions, as there may be some performance tradeoffs.

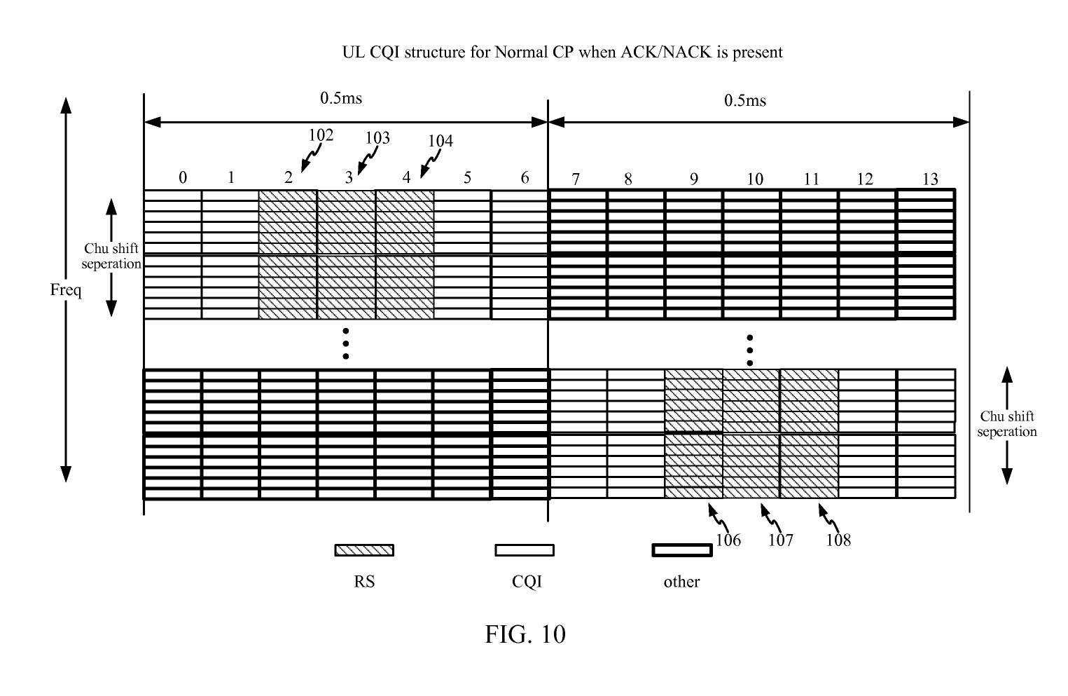

Another exemplary alternative to enhancing 2-bit ACK/NACK performance may be obtained by increasing the number of RS symbols for joint ACK+CQI transmission, as is shown in FIG. 10, where symbols 2-4 and 9-11 are used as RS symbols 102, 103, 104 and 106, 107, 108. With these 3 symbols it is possible to convey 2-bit ACK/NACK. Spreading gain is increased compared to 2 RS symbols, and an extra state DTX can be signaled if needed. While this approach may have some impact on the CQI performance as the code rate is higher, the channel estimation is better with more RS symbols.

The situation where only 2 RS symbols are used can be compared: explicit signaling of DTX is more difficult with SU-MIMO capable UEs, and higher modulation than QPSK may be needed, which increases error as well as complexity.

In contrast, with 3 RS symbols DTX can be explicitly signaled. While explicit signaling of DTX may not be needed, in practical operation, an eNB can determine whether the UE misses DL grant or not by performing blind decoding. If the RS structures are different from the one for CQI, only ACK/NACK can be assumed to be transmitted; otherwise, DTX can be assumed. Note that RS symbols can use a different base sequence from the ones used for data symbols to reduce misdetection and false alarm in the blind decoding. Alternatively, RS symbols and data symbols can use different shifts if additional shifts from the same base sequence are available.

Based on the above, it should be appreciated that with the understanding provided, one of ordinary skill in the art may make modifications to the various exemplary embodiments described herein without departing from the spirit and scope thereof.

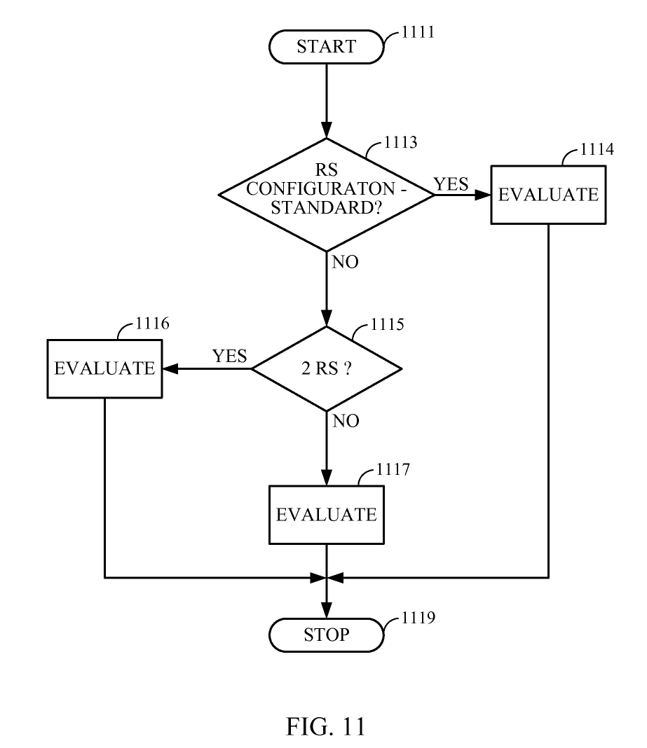

FIG. 11 depicts a flow chart illustrating an exemplary process. The exemplary process starts at 1111 and proceeds to examine the RS configuration 1113 to see if it is a standard RS format (for example, 2 separated RS tones). If it is of the standard format, then processing proceeds to evaluate 1114 the standard RS tones according to conventional methods. If it is not of the standard format (for example, not separated) then the exemplary process proceeds to determine if it is of the 2 RS tone (conjoined) format 1115. If it is 2 tone conjoined, then the exemplary process proceeds to evaluate 1116 or interpret them according to the methods described above. If it is not 2 tone conjoined, then the exemplary process evaluates 1117 them as a 3 tone or multi-tone (e.g., 4 or more tones, if so designed). At the end of each evaluation (1114, 1116, 1117), the exemplary process then stops 1119.

It is understood that the techniques described herein may be implemented by various means. For example, these techniques may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory and executed by the processors.

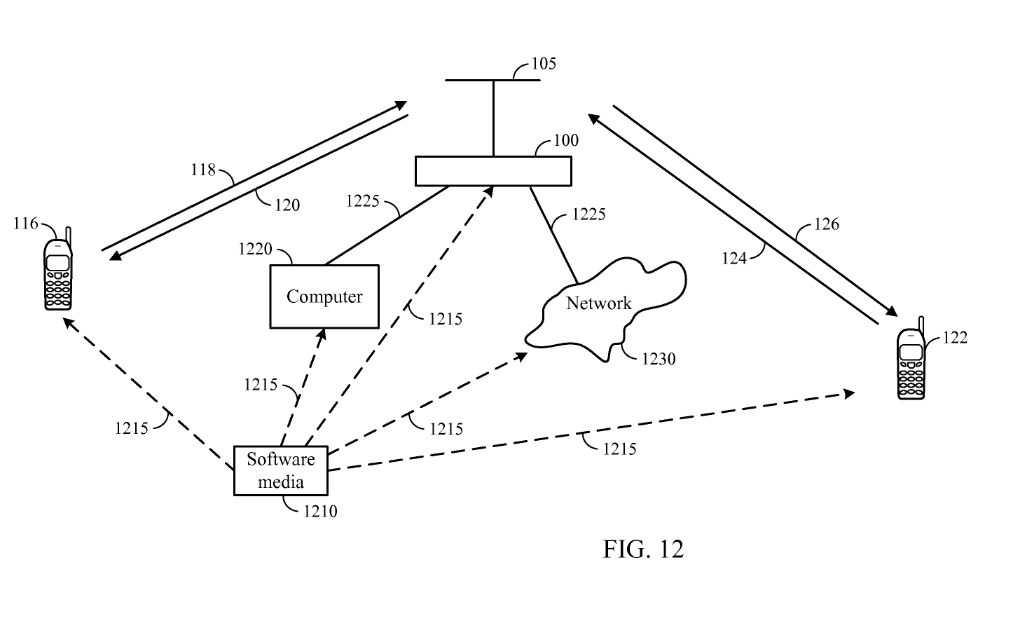

FIG. 12 depicts one possible configuration for implementing the processes described, using as one example software instructions coded onto a media. FIG. 12 shows antenna(s) 105 on access point 100 which transmits and receives to access terminals 116, 122 via wireless downlinks 120, 126 and wireless uplinks 118, 124. Software 1210 containing instructions for the above-described processes can be uploaded or incorporated either in part or in whole to the access point 100, access terminals/UEs 116, 122, computer 1220, and/or network 1230 (that is connected to the access point 100 via communication channel(s) 1225) using any one of communication links 1215, to arrive at the access terminals 116, 122. The software instructions can also be coded into memory resident on the access terminals 116, 122, as possibly RAM, ROM, programmable memory or any available mechanism for encoding instructions for use by a processor.

It is noted that various aspects are described herein in connection with a terminal A terminal can also be referred to as a system, a user device, a subscriber unit, subscriber station, mobile station, mobile device, remote station, remote terminal, access terminal, user terminal, user agent, or user equipment. A user device can be a cellular telephone, a cordless telephone, a Session Initiation Protocol (SIP) phone, a wireless local loop (WLL) station, a PDA, a handheld device having wireless connection capability, a module within a terminal, a card that can be attached to or integrated within a host device (e.g., a PCMCIA card) or other processing device connected to a wireless modem.

Moreover, aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving voice mail or in accessing a network such as a cellular network. Of course, those skilled in the art will recognize many modifications may be made to this configuration without departing from the scope or spirit of what is described herein.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for communicating handshaking information using reference signals (RSs) in a wireless communications system, comprising:
placing RS symbols in a packetized transmission to facilitate signaling of at least one of ACK/NACK, channel quality indicator (CQI), and discontinuous transmission (DTX) information.

2. The method of claim 1, wherein a plurality of RSs are spaced close to each other.

3. The method of claim 1, wherein the RSs are modulated according to quadrature phase shift keying to transmit two bits of information per slot.

4. The method of claim 1, further comprising utilizing a different shift for the RSs from those used for data symbols.

5. The method of claim 1, further comprising utilizing a different base sequence for the RSs from those used for data symbols.

6. The method of claim 1, wherein if a structure of the RSs is different from a structure used for CQI, then ACK/NACK is the information being conveyed.

7. An apparatus for communicating handshaking information using reference signals (RSs) in a wireless communications system, comprising:
means for placing RS symbols in a packetized transmission to facilitate signaling of at least one of ACK/NACK, channel quality indicator (CQI), and discontinuous transmission (DTX) information.

8. The apparatus of claim 7, wherein a plurality of RSs are spaced close to each other.

9. The apparatus of claim 7, wherein the RSs are modulated according to quadrature phase shift keying to transmit two bits of information per slot.

10. The apparatus of claim 7, further comprising a different shift for the RSs from those used for data symbols.

11. The apparatus of claim 7, further comprising a different base sequence for the RSs from those used for data symbols.

12. The apparatus of claim 7, wherein if a structure of the RSs is different from a structure used for CQI, then ACK/NACK is the information being conveyed.

13. A wireless communication device for communicating handshaking information using reference signals (RSs) in a wireless communications system, comprising:
an RS component that places RS symbols in a packetized transmission to facilitate signaling of at least one of ACK/NACK, channel quality indicator (CQI), and discontinuous transmission (DTX) information.

14. The device of claim 13, wherein a plurality of RSs are spaced close to each other.

15. The device of claim 13, wherein the RSs are modulated according to quadrature phase shift keying to transmit two bits of information per slot.

16. The device of claim 13, further comprising a different shift for the RSs from those used for data symbols.

17. The device of claim 13, further comprising a different base sequence for the RSs from those used for data symbols.

18. The device of claim 13, wherein if a structure of the RSs is different from a structure used for CQI, then ACK/NACK is the information being conveyed.

19. A computer program product comprising:
a computer-readable medium comprising:
code for communicating handshaking information using reference signals (RSs) in a wireless communications system by placing RS symbols in a packetized transmission to facilitate signaling of at least one of ACK/NACK, channel quality indicator (CQI), and discontinuous transmission (DTX) information.

20. The computer program product of claim 19, wherein a plurality of RSs are spaced close to each other.

21. The computer program product of claim 19, wherein the RSs are modulated according to quadrature phase shift keying to transmit two bits of information per slot.

22. The computer program product of claim 19, further comprising code for utilizing a different shift for the RSs from those used for data symbols.

23. The computer program product of claim 19, further comprising utilizing a different base sequence for the RSs from those used for data symbols.

24. The computer program product of claim 19, wherein if a structure of the RSs is different from a structure used for CQI, then ACK/NACK is the information being conveyed.

25. An apparatus communicating handshaking information using reference signals (RSs) in a wireless communications system, comprising:
a processor, configured to control operations for:
placing RS symbols in a packetized transmission to facilitate signaling of at least one of ACK/NACK, channel quality indicator (CQI), and discontinuous transmission (DTX) information; and
a memory coupled to the processor for storing data.

26. The apparatus of claim 25, wherein a plurality of RSs are spaced close to each other.

27. The apparatus of claim 25, wherein the RSs are modulated according to quadrature phase shift keying to transmit two bits of information per slot.

28. The apparatus of claim 25, further comprising utilizing a different shift for the RSs from those used for data symbols.

29. The apparatus of claim 25, further comprising utilizing a different base sequence for the RSs from those used for data symbols.

30. The apparatus of claim 25, wherein if a structure of the RSs is different from a structure used for CQI, then ACK/NACK is the information being conveyed.
